(19) United States
(12) Patent Application Publication
(10) Pub. No.: US 2013/0311215 A1
(43) Pub. Date: Nov. 21, 2013

(54) SUSTAINABILITY BASED DISTRIBUTION EVALUATION

(71) Applicants: Martina ROTHLEY, Schwetzingen (DE); Johann KEMMER, Muehlhausen (DE)

(72) Inventors: Martina ROTHLEY, Schwetzingen (DE); Johann KEMMER, Muehlhausen (DE)

(73) Assignee: SAP AG, Walldorf (DE)

(21) Appl. No.: 13/473,247

(22) Filed: May 16, 2012

(51) Int. Cl. G06Q 10/08

(52) U.S. Cl. 705/7.11

(57) ABSTRACT

A computer implemented method for analyzing distribution options of a product can include obtaining data relating to the distribution of the product to a customer from at least one supplier. The method can include configuring one or more criteria relating to the distribution of the product and weighting the criteria. At least one criteria can relate to sustainability of the distribution of the product. The method can include performing green distribution analysis on the distribution options of the product based on the weighted criteria using the obtained data and providing a set of distribution options based on the green distribution analysis. The distribution options can be provided with a green distribution score corresponding to the sustainability of the distribution option.

### RELATED APPLICATIONS

The present application is related to U.S. patent application Ser. No. ______, filed on May 16, 2012, Attorney Docket: 11884/522601, entitled “Product Sustainability Evaluation,” hereby incorporated by reference.

### BACKGROUND

As sellers and buyers show increased interest in environmental protection, in order to effectively compete in today's markets, companies must change their operations to be more environmentally friendly. Thus, companies are searching for tools and methods to help them reduce the impact that their operations have on the environment. In these efforts, companies are looking for ways to be more eco-friendly without significantly reducing their profit margins.

Companies have taken steps to reduce their carbon footprint by recycling, using recycled materials in their products and relying on renewable energy sources. However, limited tools are available to evaluate these efforts. In addition, companies do not have effective tools that can provide them with options that can be taken to reduce their carbon footprint. Companies also do not have effective tools to compare the different available options and the impact on the environment that the options may have. For example, a company may decide to take steps to reduce the carbon footprint caused by the mode of transportation used to transport a product, but may lack a system and process to present the available options and to evaluate the available options.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 illustrates a flow diagram of a method to perform green distribution analysis for distributing a product to a customer, according to an exemplary embodiment.

FIG. 2 illustrates a flow diagram of a method to perform green distribution analysis for distributing a product to a customer from one or more suppliers, according to an exemplary embodiment.

FIG. 3 illustrates a table showing a score being assigned to each of criteria for available distribution options, according to an exemplary embodiment.

FIG. 4 illustrates a table showing criteria for available distribution options, according to an exemplary embodiment.

FIG. 5 illustrates a flow diagram of a method to perform green distribution analysis of a currently used method of distributing a product to a customer from one or more suppliers, according to an exemplary embodiment.

FIG. 6 illustrates a block diagram of an exemplary system for performing the green distribution analysis for supplying a product to a customer, according to an exemplary embodiment.

FIG. 7 illustrates a graphical display of analysis results for several delivery options, according to an exemplary embodiment.

FIG. 8 illustrates a block diagram of an exemplary computer system.

### DETAILED DESCRIPTION

Various embodiments of systems and methods for evaluating the distribution of a product to make sales and distribution greener are described herein. A method for analyzing distribution options of a product can include obtaining data relating to the distribution of the product to a customer from at least one supplier. The method can include configuring one or more criteria relating to the distribution of the product and weighting the criteria. At least one criteria can relate to sustainability of the distribution of the product. The method can include performing green distribution analysis on the distribution options of the product based on the weighted criteria using the obtained data and providing a set of distribution options based on the green distribution analysis. The distribution options can be provided with a green distribution score corresponding to the sustainability of the distribution option.

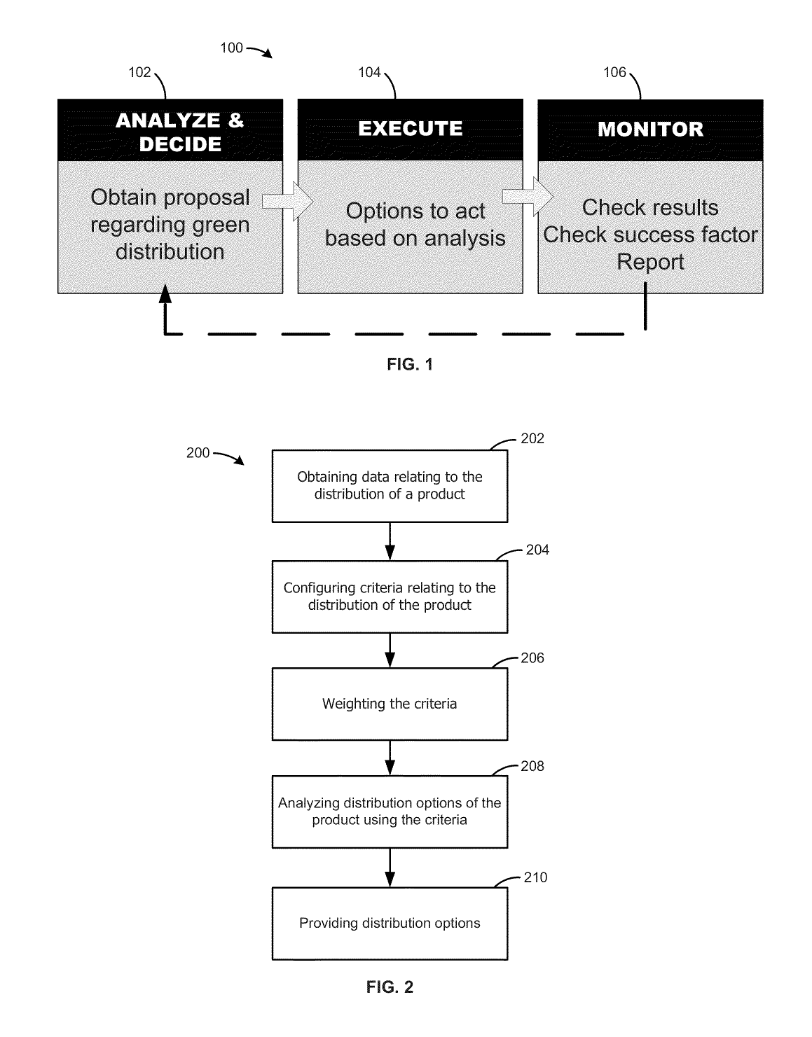

FIG. 1 illustrates a flow diagram of a method 100 to perform green distribution analysis for distributing a product to a customer, according to an exemplary embodiment. The exemplary embodiment can include step 102 in which an analysis and a decision can be performed to obtain a proposal regarding green distribution, step 104 in which execution can be performed of one of the options based on the proposed green distribution option, and step 106 in which monitoring can be performed to check the results and the success factor of the executed action. The exemplary method 100 can be implemented by a computer and may be implemented in an integrated information management system.

As used herein, the term “green” can relate to ecologically sustainable practices, measures, metrics or characteristics. The one or more criteria can be used to evaluate green distribution of a product and/or the sustainability of a product or packaging. The one or more criteria may refer to material(s) used in the product, material(s) used in the manufacturing process of the product, design and functionality of the product, extraction and processing of materials, packaging, distribution, manufacturing processes, mode of transportation, mode of storing, emission control measures, distance between the supplier and a procurement site (of purchaser/customer), distance between the supplier and a storage facility, energy management measures, waste disposal measures, environmental policies, compliance certificates, low carbon emission manufacturing material, waste disposal measures, emission control measures, use of alternative fuels, recyclable packaging material, renewable energy source employed by the supplier for manufacturing, storing or transporting, and recycled or recyclable materials used in the product. The one or more criteria may be provided as one or more metrics and may include the weighting of the criteria and the interdependencies of the one or more criteria.

The terms “commodity,” “good,” and “product” can be used interchangeably and can refer to one and the same. The term “freight forwarder” can refer to a business partner in the role of a supplier, a dealer, a manufacturer, a producer, a contractor, a distributor, a retailer, or a seller dealing with the distribution of a product.

The term “customer” may refer to a purchaser or a consumer, or other entity that may purchase or request to be supplied with a product.

In the exemplary embodiments, the integrated information management system can be an Enterprise Resource Planning (ERP) system having a plurality of business modules which are integrated to each other. The business modules can be integrated to each other over a communication network. The ERP system can be enabled with automated pull mechanisms allowing real-time processing and execution of inspection data. As used herein, the term “real-time” can refer to a time frame that is brief, appearing to be immediate or near concurrent. When the computer processes data in real time, it can read and handle data as it is received, producing results without significant delay.

In step 102 an analysis may be performed on the one or more customers requesting a product and on the one or more suppliers of the requested product. The analysis may include analyzing the product, the supplier of the product, the freight forwarders of the product, means of transportation, or the type of packaging used. The analysis may be performed based on the one or more criteria. The analysis may include performing an evaluation on the alternative options regarding the transporting of the product, alternative options for the type of packaging that can be used for the product, and any options regarding using green methods to distribute the product. The alternative options regarding the transporting of the product may include the alternative distances that can be traveled by a particular mode of transportation or the distance of a particular route, or the alternative modes of transportation. The analysis may also include the cost and/or time for the delivery associated with each of the alternatives considered in the analysis.

In step 102 a decision may be made on the available distribution options based on the analysis performed on the one or more customers requesting a product, on the one or more suppliers of the requested product, and the way the product is distributed. The decisions can be made on how to characterize the available distribution options. The provided distribution options may be for more adequate freight forwarders, means of transportation and packaging in terms of the sustainability of the distribution. Cost of the distribution options can be a factor considered in making the decision. Thus, the decision can be made based on objective criteria. In addition, the decision can be based on criteria which are interdependent on other criteria.

In step 104 an execution may be made to select one of the proposed or recommended distribution options. The selection may be made automatically or selected by a user from proposed distribution options. The selection may include contacting a new supplier and/or a new freight forwarder with the green means of transportation. The selection may include reducing the number of freight forwarders used to deliver the product, changing the freight forwarders used, changing the mode of transportation used to deliver the product, or changing the type of packaging used for the product.

In step 106 monitoring may be performed to check the results of the selected option. The monitoring may include determining and checking the success of the decision to change one or more factors included in the distribution of the product. For example, a determination may be made to check the cost savings, reduction of carbon footprint due to the change, and change in the green image of the company. The monitoring step may also include monitoring the green industry trends to determine if any additional changes may be made to improve the green distribution of the product. The improvement may include improving the image of the company, reducing the carbon footprint caused by the distribution of the product, reducing cost, or reducing delivery time. The monitoring step may also include an option to include new green product features or criteria to be analyzed and decided in step 102.

FIG. 2 illustrates a flow diagram of a method 200 to perform green distribution analysis for distributing a product to a customer from one or more suppliers, according to an exemplary embodiment. The exemplary embodiment of method 200 may include step 202 to obtain data relating to the distribution of a product, step 204 to configure criteria relating to the distribution of the product, step 206 to weight the criteria, step 208 to analyze distribution options of the product using the criteria, and step 210 to provide distribution options.

In step 202, data may be obtained relating to the distribution of the product to a customer from one or more suppliers. The data may be obtained from a database storing the information relating to the product, the supplier, the distributor, the freight forwarder, or the customer. The information may be obtained from web services, expert judgment using questionnaires, or integrated enterprise resource planning (ERP) system(s). The information may be stored in a computer or an integrated information management system. The information may be retrieved from one or more data source systems in communication with the computer over an integrated network. The data source systems may be maintained by the supplier of the product, the distributor or other entity associated with the distribution of the product.

The information may be manually entered, automatically generated based on supplied information or retrieved from databases. The information may be provided by the distributor of the product, the manufacturer of the product, the freight forwarder of the product or the supplier of the product. For example, the freight forwarder may enter information such as the originating location, the mode of transportation, the distance to be traveled by each mode of transportation and the type of packaging that can be used or was used during the transportation of the product. Similarly, the supplier of the product may enter information such as the location of the product, mode of transporting the product, what kind of packaging is acceptable for the particular product or if any special handling procedures should be followed while transporting the product. The information may be requested from the supplier or the freight forwarder using a questionnaire, such as an electronic questionnaire. Even the customers of the product could be asked for information.

The information may be automatically collected by monitoring devices mounted on the vehicles used to transport the product, or scanning identification devices, such as bar codes or RFID tags, on the transportation means, the product or the packaging.

The data that is obtained may include information associated with the distribution of the product. The data may include information to be used in the one or more criteria that can be used to evaluate the sustainability of the product or the distribution of the product. For example, the data may include the originating location of the product, the destination of the product, the location of the customer, the location of storage facilities, the route to be taken by a distributor, the mode of transportation that can be used for a particular product, the times that a particular mode of transportation means is available, the amount of time it takes to travel between specified locations, distance to be traveled, materials used in the product, material used to manufacture the product, the type of packaging used for the product, the type of packaging that should be used while transporting the product, special handling instructions, cost associated with the packaging, and cost for various transportation modes.

The data may also include information relating to ecologically sustainable practices, measures, metrics or characteristics. For example, the data may include the cost associated with renewable and nonrenewable resources, the benefit factor due to using renewable resource or nonrenewable resource, carbon footprint reduction due to using renewable resource or nonrenewable resource, “green” industry trends, government regulations, certification requirements, and incentive programs used to encourage green distribution or manufacturing practices.

In step 204, criteria relating to the distribution of the product may be configured. The criteria can include one or more criteria used to evaluate the alternative distribution options. The criteria to be used in the analysis can be objective criteria to provide a transparent method of evaluating the distribution options. The criteria can include the minimal distance between involved parties, fastest route between involved parties, best mode of transportation, best packaging for the product, transportation cost, and carbon emissions. Other criteria mentioned with reference to the exemplary embodiment shown in FIG. 1 may be included in the exemplary embodiment.

The criteria to be used in the method can be manually selected by a user. The criteria to be used can also be automatically selected based on, for example, the type of product being delivered, acceptable practices in the industry, available data, geographical location of supplier or customer, or green industry trends. An initial set of criteria can be used and additional criteria can be input by a user or automatically added after a predetermined amount of time, after an initial evaluation has been performed or after additional data is provided. Similarly one or more of the criteria can be removed from the initial set of criteria. The criteria can also be changed when changes occur in the economy, industry or green distribution standards. Additional criteria can be added or removed by the distributor, freight forwarder or the supplier.

Criteria for the minimal distance or the fastest route between involved parties may include the location of the storage facility, distribution center, freight forwarder, or customer. The minimal distance and the fastest route criteria may include the factors influencing the minimal distance and fastest time due to a freight forwarder delivering a product to multiple customers from multiple distribution locations. For example, a freight forwarder can pick up the products from the same location for multiple customers in different locations or the freight forwarder can deliver products from multiple storage locations to multiple customers in the same region.

The best mode of transportation criteria may include modes of transportation such as car, van, truck, train, ship or plane. Factors that can be considered with this criteria can include the size of the mode of transportation, the size of the product, ability to bundle different deliveries on the same mode of transportation for the same or different customers in the same geographical area, the cost associated with the mode of transportation, whether renewable energy sources are used, amount of pollution produced, and reduction on traffic congestion caused by using the particular mode of transportation. When bundling multiple deliveries, constraints can be included to ensure that the product is delivered on time.

The best packaging criteria can include factors such as ability to reuse the packaging, minimizing waste of packaging material, and minimal weight of the packaging. The factors may also include the sustainability of the packaging material, such as, whether recycled products were used in the packaging material and whether the packaging material can be recycled.

In step 206, weighting of the criteria may be performed. The weighting of the criteria may include assigning a weighting factor to each of the criteria. The weighting of the one or more criteria within a system may be configured to reflect an organization's internal values, priorities, and thresholds with respect to sustainability. Thus, more weight can be assigned to criteria that represent valued sustainability practices. For example, criteria that are more important to achieve a reduction in the carbon footprint may be assigned a higher weighting factor and criteria that are less important may be assigned a lower weighting factor. The weighting of the criteria may also be performed on a portion of the criteria. For example, the mode of transportation and the type of packaging may only be assigned a weighting factor.

The weighting may be performed manually by a user or automatically. The weighting may be performed automatically based on the type of product being delivered, acceptable practices in the industry, geographical location of supplier or customer, green industry trends, green industry standards or customer preferences. The weighting may also be adjusted in real time or periodically changed as changes occur in the world effecting the green distribution of the product. For example, if customers receiving a particular product are willing to pay a higher price for the delivery of the product as long as the mode of transportation uses a renewable power source, then the criteria for the mode of transportation may receive a higher weighting factor while the criteria for transportation cost may receive a lower weighting factor.

In step 208, the distribution options of the product may be analyzed using the weighted criteria. The analysis may include generating the available distribution options and assigning values to the criteria in the available distribution options. Using the obtained data, options may be generated that are available to distribute the product. Multiple distribution options may be provided for a given freight forwarder if the freight forwarder can deliver the product using different modes of transportation, different types of packaging, and/or different routes.

The values assigned may be assigned to the criteria to encourage the reduction of the carbon footprint due to distributing the product and to make the distribution of the product more eco-friendly. For example, the values may be assigned with the goal of reducing or minimizing the transportation distance, using more eco-friendly means of transportation, and using sustainable packaging. Thus, lower values may be assigned to modes of transportation that produce more pollution or consume more fuel and higher values may be assigned to means of transportation that use renewable resources.

Each of the available distribution options may receive a green distribution key performance indicator (KPI) using the one or more criteria. The green distribution KPI for a particular distribution option may be assigned based on the values in the one or more of the criteria for the particular distribution option. In step 210, the available distribution options may be provided with the green distribution KPI. The available distribution options may be provided with a ranking based on the green distribution KPI. Using the results of the analysis, one of the distribution options may automatically be selected, a recommendation may be made to use one or more of the distribution options, or a user may be given an option to select one of the distribution options. If an automatic decision is made, a user may be allowed to confirm the change triggered by a business task sent into his mail inbox.

The available distribution options can be displayed based on whether the distribution options meet certain predefined conditions. For example, before a distribution option is displayed as an available option, the distribution option may need to satisfy one or more criteria. A threshold value may be set to one or more of the criteria and the distribution option can be displayed only if the values in the criteria exceed the set threshold values. The threshold value in one or more criteria can also be used to determine which of the available distribution options are green distribution options. Distribution options that are not green can be disregarded from the analysis or from being offered as an available distribution option.

The green distribution KPI for a particular distribution option may be calculated based on a score assigned to each of the criteria. For example, the mode of transportation can be classified using a standardized reference value which can be used to calculate the green transportation score for each mode of transportation, e.g., energy consumed per distance traveled and weight of the freight. Similarly, the type of packaging used can be classified by assigning the green packaging score based on the sustainability of the material used in the packaging, e.g., reusable container, recyclable materials, or recycled materials.

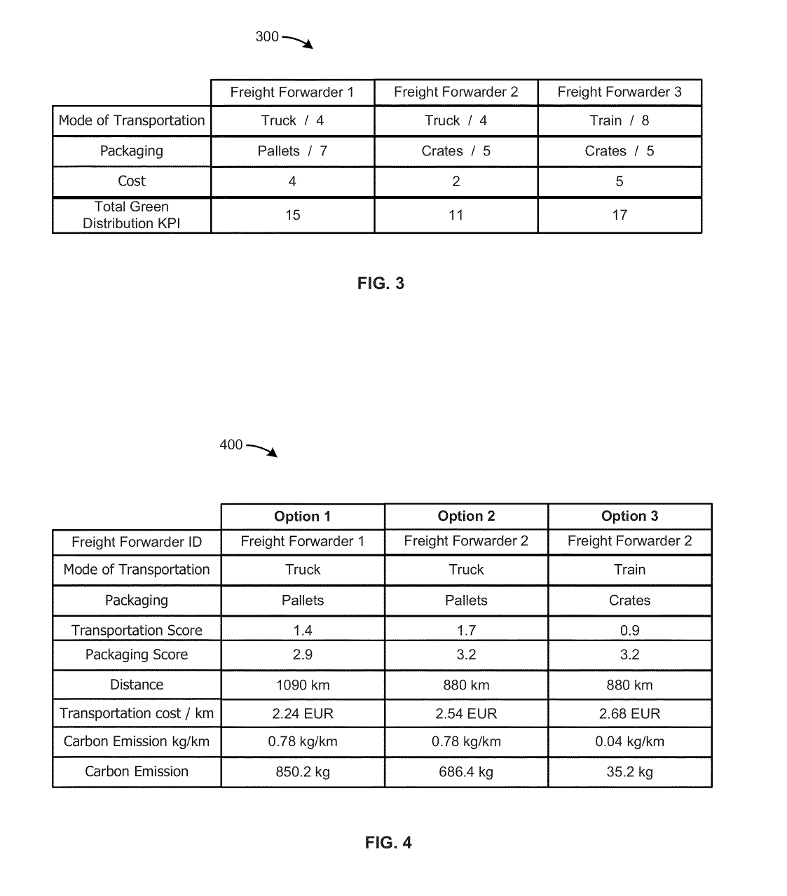

FIG. 3 illustrates a table 300 showing a score being assigned to each of the criteria for available distribution options, according to an exemplary embodiment. In the example, a higher score corresponds to more eco-friendly green distribution. The green distribution KPI for a particular distribution option can be the sum of the scores for each of the criteria. The score in each of the criteria can be assigned based on how eco-friendly the option is for the criteria. For example, because the mode of transportation by a train can be considered to produce less pollution, a higher score can be assigned to the mode of transportation criteria for freight forwarder 3. With the total green distribution KPI for each of the freight forwarders, the freight forwarders can be ranked and a recommendation can be made to use freight forwarder 3, because a higher total green distribution KPI can correspond to more eco-friendly operations. The score for each of the criteria can be assigned based on the weighting performed in step 206.

FIG. 4 illustrates table 400 showing criteria for available distribution options, according to an exemplary embodiment. FIG. 4 illustrates three options for two different freight forwarders. Freight forwarder 2 provides two distribution options, a distribution option using a truck and a distribution option using a train. The green distribution KPI for each of the options can be calculated using the transportation score and the packaging score provided in the table. The transportation score and the packaging score can reflect how eco-friendly are one or more of the modes of transportation, type of packaging, cost of transportation, and amount of generated carbon emission. The transportation score and the packaging score can be weighted to determine the green distribution KPI. Alternatively, the weighting of the criteria can already be incorporated in the provided score for the transportation score and the packaging score.

In addition to the transportation score and the packaging score, other criteria values provided in the obtained data can be used to calculate the green distribution KPI. For example, the green distribution KPI can be calculated for each option using the transportation score, the packaging score, and amount of time in transit. The amount of time in transit can be converted to a score that can be combined with the transportation score and the packaging score to obtain the green distribution KPI.

The weighting of the criteria and assigning of scores to the criteria can be configured to select or propose a freight forwarder with the shortest possible distance to the customer using green means of transportation and green packaging. Thus, the proposal can reduce the distance to the customer, reduce the carbon footprint due to the mode of transportation and the type of packaging used. Because shorter distance that has to be traveled and lighter and renewable packaging materials can reduce the cost associated with distributing the product, cost savings can be achieved by the seller which can be offered to the customer. If the green means of transportation and green packaging cause an increase in the cost to distribute the product, a determination can be made automatically or by the distributor or the seller as to how much of an increase in cost justifies the use of green means of transportation and green packaging.

In analyzing the freight forwarders, some of the distribution options can be disregarded if certain predetermined thresholds are not met by the criteria. For example, a threshold can be set for the distance not to exceed a predetermined value. Thus, certain options with freight forwarders who can deliver the product can be disregarded if they have a distance criterion which exceeds the predetermined value. Similarly, a threshold can be set for other criteria such as transportation cost and amount of carbon emission.

The exemplary method may also consider the interdependencies between the criteria. The interdependence of the criteria may be considered because one criteria may limit whether options in another criterion are available to be used together. In addition, the benefit of using a particular option in one criterion may be outweighed by the other criteria. For example, the most eco-friendly mode of transportation may require packaging for a particular product that is heavy and produces a significant amount of waste. In addition, the distance between locations and the amount of time required to deliver the product may cause some modes of transportation not to be practical. The interdependence of the criteria may be considered when assigning the weighting factor to the criteria or when analyzing the available distribution options.

Constraints can be included to consider the interdependencies of the criteria. Examples of the one or more constraints include conditions involving interrelations such as: distance Vs mode of transport, waste disposal measures Vs zero by-product manufacturing material, waste disposal measures Vs climatic conditions, packaging material Vs mode of transport, carbon emission control Vs low carbon emission manufacturing material, source of energy Vs Geographic location, packaging Vs climatic conditions of the region. The constraints can be used to set the weighting factor to the criteria. In an example, a condition involving a distance from source to destination and mode of transport may be defined as: <<For distance>X Kms, set higher weight to the mode of transportation and lower the weight of the type of packaging>>.

In step 210 the distribution options can be provided to a user, such as a seller, freight forwarder or distributor, to allow the user to select which of the distribution options should be used to distribute the product. The user can be provided with a proposal based on objective criteria for a more adequate freight forwarder, means of transportation and packaging in terms of sustainability, and lower cost. Thus, the user may have the option of selecting which of the modes of transportation, packaging or routes should be used to distribute the product. The user may have the option to select a mode of transportation and packaging that cost more but does more to reduce the carbon footprint that may be left by the particular distribution option. The user may also be provided with the green distribution KPI for each option, to show the user the contribution that the particular method of distributing the product makes in reducing the carbon footprint. The user may also be provided with the total cost associated with each of the available distribution options.

After providing distribution options in step 210, the exemplary embodiment can be configured to repeat the steps of the method. The steps may be repeated if additional or updated data is received, if criteria are added or removed, if freight distributors are added or deleted, if green industry trends change, or if other changes occur effecting the distribution of the product or how sustainability is measured. The steps of the exemplary method can be repeated to determine if any of these changes can be used to improve the green distribution KPI.

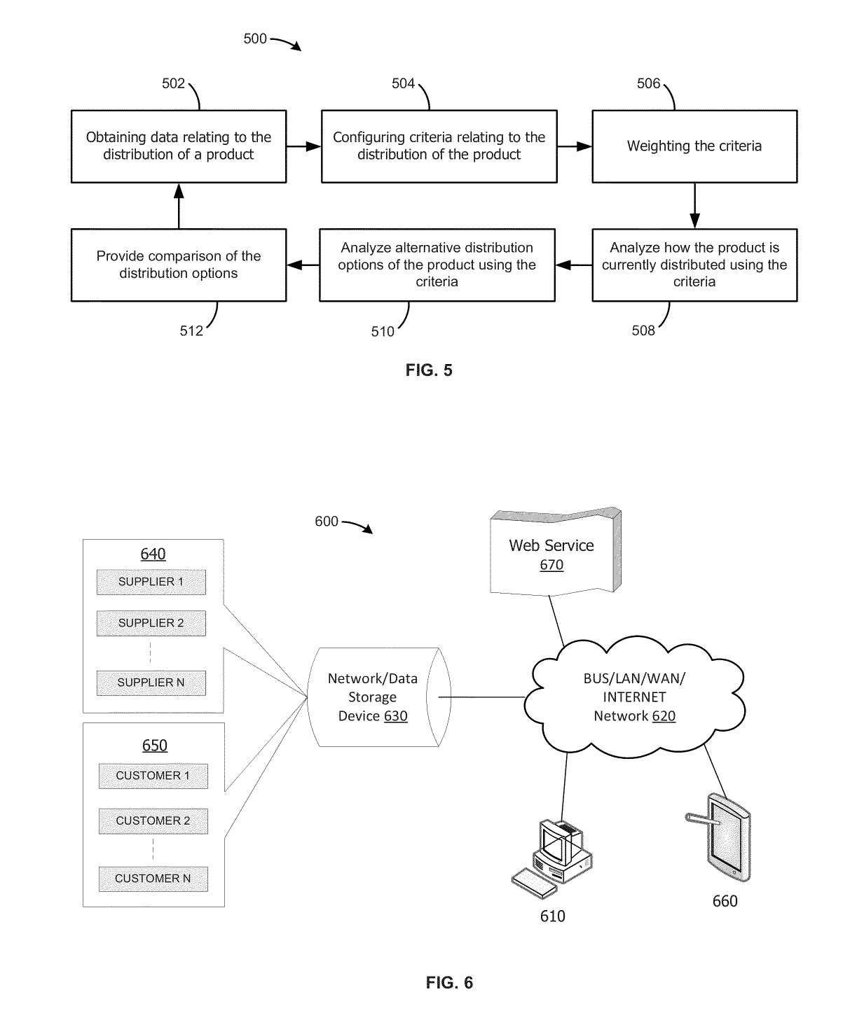

FIG. 5 illustrates a flow diagram of a method 500 to perform green distribution analysis of a currently used method of distributing a product to a customer from one or more suppliers, according to an exemplary embodiment. The exemplary embodiment of method 500 may include step 502 to obtain data relating to the distribution of the product, step 504 to configure criteria relating to the distribution of the product, step 506 to weigh the criteria, step 508 to analyze how the product is currently distributed using the criteria, step 510 to analyze alternative distribution options of the product using the criteria, and step 512 to provide a comparison of distribution options.

The exemplary embodiment shown in FIG. 5 can include steps similar to the exemplary embodiment shown in FIG. 2, but can also include steps to analyze how the product is currently distributed and compare this analysis to the analysis of the available alternative distribution options. In particular, in step 508 analysis can be performed on the existing distribution method of the product. The analysis may include determining the green distribution KPI score of the existing distribution means using the one or more criteria.

In step 510 analysis can be performed on alternative distribution options of the product using the one or more criteria. The analysis may include determining the green distribution KPI score of the alternative distribution options using the one or more criteria.

Using the results of the analysis from the existing distribution method and the alternative distribution options, a comparison can be provided in step 512. Step 512 can also include providing a recommendation on which of the alternative distribution options can be used instead of the existing distribution method. Step 512 can also provide a recommendation as to whether the existing distribution method should be used or whether one of the alternative distribution options should be used.

FIG. 6 illustrates a block diagram of a system 600 for performing the green distribution analysis for supplying a product to a customer, according to an exemplary embodiment. The system 600 may include computer 610, network 620, storage device 630, supplier data source 640, customer data source 650, control device 660 and web service 670. The computer 610, storage device 630, control device 660 and web service 670 can be coupled to each other via the network 620.

The computer 610 may control the integrated information management system which can be an ERP system having a plurality of business modules which are integrated to each other. The computer 610 may include a processing unit, a storage device and input and output devices. The computer 610 may perform the exemplary methods to analyze the distribution options of a product from one or more suppliers using the one or more criteria and provide green distribution analysis results to a user or to make automatic selection of a an eco-friendly distribution option.

The computer 610 may be configured to select freight forwarders that can deliver the product to a customer and analyze the distances between the freight forwarders, the storage locations and the customers. The computer 610 can be configured to determine if the distance can be shortened by changing the freight forwarder. The computer 610 can also be configured to provide a search functionality to find alternative freight forwarders and compare the performance based on one or more criteria of the current freight forwarder and one or more alternative freight forwarders.

The computer 610 may also be configured to select the mode of transportation. Analysis can be performed on the mode of transportation currently used and alternative modes of transportation to determine if the alternative modes of transportation are more sustainable. The computer 610 can be configured to provide a search functionality to find alternative modes of transportation and compare the performance based on one or more criteria of the current modes of transportation and one or more alternative modes of transportation.

The computer 610 may also be configured to analyze the packaging that can be used for the product to be delivered to the customer. The analysis can include comparing the current packaging that is used when delivering the product to alternative packaging material that can be used to deliver the product with the goal of reducing the weight and the waste produced by the packaging. The computer 610 can provide a search functionality to find alternative packaging materials that can be used with the various modes of transportation and/or products.

The computer 610 may also be configured to provide a cost comparison between the current transportation and the potentially more sustainable alternatives. The cost comparison can be used by a seller, a distributor or a freight forwarder to check the impact on the profitability that switching to a more sustainable alternative may make. The cost comparison can also be used in the negotiation with potential freight forwarders or distributors or even with eco-hearted customers to show the impact some options may have on the sustainability of the distribution.

The computer 610 or the control device 660 may be used to add new criteria, to remove criteria, or to change how the criteria are weighted.

To provide a proposal for an alternative freight forwarder the computer 210 can be configured to determine if a predetermined threshold value for one or more criteria has been met. The proposal can be made based on a score calculated for each freight forwarder based on one or more criteria. The alternative options that can be used for the distribution can include planning deliveries that bundle the products and optimizes the deliveries to multiple customer or from multiple distribution centers. A distributor, such as a supply planner, can receive information about the results of the analyses (e.g., via a business task). The supply planner can be provided with the details of the report showing the KPI scores and/or a ranked list of the freight forwarders including one or more of the mode of transportation, the type of packaging that can be used, the distance, the cost, and the reduction of carbon footprint. The supply planner can make a decision based on the received information. Optionally, an approval workflow can be started after the supply planner makes a decision.

A log can be created explaining the details and results of the analysis. The log can be displayed on the computer 610 or control device 660, or stored on the computer 610 or storage device 630. The log can include information used to perform the analysis and analysis results. The log may include current distance to a customer, new distance to a customer, distance reduction in km, miles and percentage, calculation of green transportation score, calculation of green packaging score, change of freight forwarders with identical conventional mean of transportation, change of freight forwarders with identical green means of transportation, change of freight forwarder with different means of transportation, and weighting of the criteria.

The computer 610 may also be configured to monitor and report the carbon footprint reduction due to using the alternative distribution options. The seller's reporting can be provided to the customer, producer of the product, distributor, freight forwarder or government agency. The reporting can be used to prove eco-friendliness or provide certification that a product is environmentally friendly or that the product meets certain standards. The reporting can include providing the sustainability reports of each available distribution option.

Network 620 may include a LAN, WAN, bus, or the Internet. The storage device 630 may be used to store the data associated with the distribution of a product. The storage device 630 may be a part of the ERP system. In some embodiments the network storage device 630 may also be separate from the ERP system but connected to it through the network 620. The storage device 630 may contain a hard disk drive, flash memory, or other computer readable media capable of storing data.

The storage device 630 may be coupled to a supplier data source 640 that can provide information regarding the distribution of the products. The storage device 630 may also be coupled to a customer data source 650 that can provide information regarding the customer requesting the products. The information provided by the supplier data source 640 and the customer data source 650 may be provided from the same source. The customer and supplier information may be provided from a system monitoring and processing orders for the products.

The computer 610 can be configured to periodically analyze the data stored in the storage device 630 to optimize the distribution processes regarding the green features. The data that can be periodically analyzed and can include the customer location, freight forwarder location, distribution and storage center locations, mode of transportation, type of packaging and other data associated with the distribution of the product.

Control device 660 may be included for a user to enter information relating to the distribution of the product or to make adjustments to the way a product is distributed. For example, a user may enter customer or freight forwarder information using control device 660. Control device 660 may be used to display the analysis results of the delivery options and report the progress of the carbon footprint reduction. The results may also be displayed on the computer 610 or on mobile devices such as smartphone or iPads.

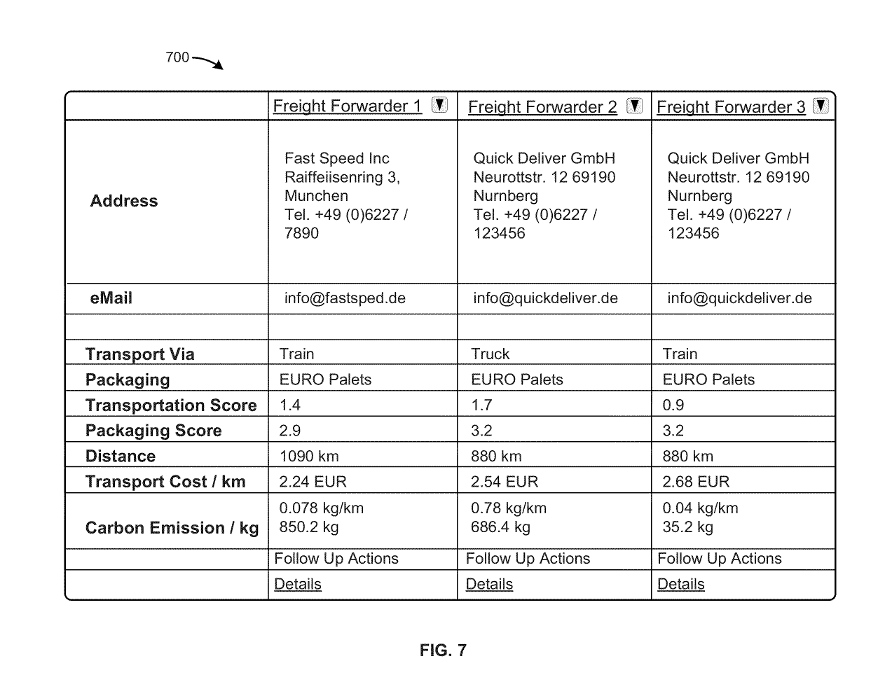

FIG. 7 illustrates a graphical display of analysis results 700 for several delivery options, according to an exemplary embodiment. The graphical display of analysis results 700, shown in FIG. 7, provide three distribution options using two different distributors. Freight forwarder 2 and freight forwarder 3 are the same distributor but use different modes of transportation to deliver the product. The analysis results can provide information relating to the address and contact information of the freight forwarder for each available option, the type of transportation and packaging that can be used, the transportation score, the packaging score, the distance, the cost per distance traveled, the carbon emission per distance traveled and total carbon emission for each option. The analysis results may also provide an option for follow-up actions or for more detailed information about each delivery option. The follow-up action may include contacting the freight forwarder to schedule a delivery, requesting more information, or updating information relating to the distribution of the product. The detailed information about each delivery option may include customer or supplier reviews of the freight forwarder, or delivery history.

A web service 670 may be used to find alternative freight forwarders to be analyzed and compared. The web service may find the alternative freight forwarders who are located within a predefined distance from the customer and/or the storage location. The web service may also be used to provide information to be displayed on the computer 610 or the control device 660 about the freight forwarder, the mode of transportation offered, the cost associated with each mode of transportation and type of packaging, amount of carbon emission that can be produced, or terms and conditions of a contract. The web service 670 may be used to monitor and report on the current trends in the industry of the product, green industry trends, changing politics or distribution cost.

The control device 660 or the computer 610 may be used to display a map showing the customer locations and freight forwarder locations. The map may include the information about each of the freight forwarder, the route that can be traveled by each freight forwarder, and the green distribution score associated with each of the options provided by the freight forwarders. The system 600 may include a route planner to calculate and show the distance between the customer, freight forwarders and the storage locations. The route planner may take into account the mode of transportation that will be used to distribute the product when calculating the distance and determining the route.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments of the invention may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components can be tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

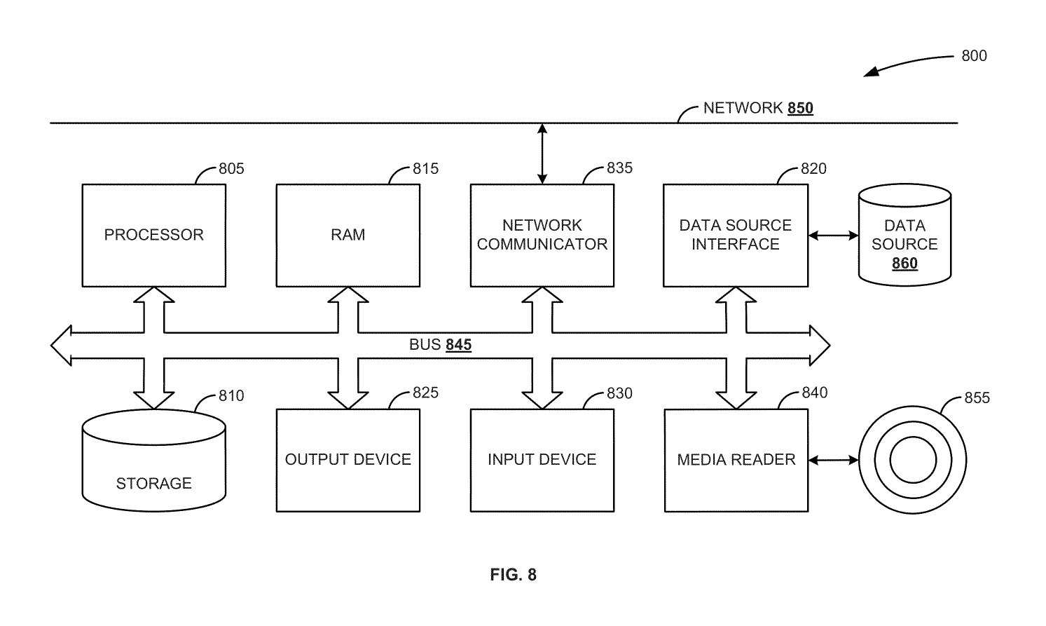

FIG. 8 illustrates a block diagram of an exemplary computer system 800. The computer system 800 can include a processor 805 that executes software instructions or code stored on a computer readable storage medium 855 to perform the above-illustrated methods of the invention. The computer system 800 can include a media reader 840 to read the instructions from the computer readable storage medium 855 and store the instructions in storage 810 or in random access memory (RAM) 815. The storage 810 provides a large space for keeping static data where at least some instructions could be stored for later execution. The stored instructions may be further compiled to generate other representations of the instructions and dynamically stored in the RAM 815. The processor 805 reads instructions from the RAM 815 and performs actions as instructed. According to one embodiment of the invention, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. Each of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

We claim:

1. A computer implemented method for analyzing distribution options of a product, comprising:
obtaining data relating to the distribution of the product to a customer from at least one supplier;
configuring one or more criteria relating to the distribution of the product, wherein at least one criteria relates to sustainability of the distribution of the product;
weighting the criteria;
performing green distribution analysis, by the computer, on the distribution options of the product based on the weighted criteria using the obtained data; and
providing a set of distribution options based on the green distribution analysis.

2. The method of claim 1, wherein the distribution options are provided with a green distribution score corresponding to the sustainability of the distribution option.

3. The method of claim 1, wherein the weighting of the one or more criteria is performed based on at least one of customer characteristics, industry standards, certification standards, government policies, regulation requirements, transportation options, fuel prices, and supplier characteristics.

4. The method of claim 1, wherein the weighting of the one or more criteria can be changed based on changing political situation, customer characteristic or supplier characteristics.

5. The method of claim 2, wherein providing the set of distribution options includes providing a recommendation on which distribution should be used based on the green distribution score.

6. The method of claim 2, further comprising automatically selecting one of the distribution options based on the green distribution score and a cost of the distribution option.

7. The method of claim 1, wherein the distribution options are ranked based on the sustainability of the distribution options.

8. The method of claim 1, wherein performing the green distribution analysis includes calculating a cost associated with each distribution option.

9. The method of claim 1, wherein the one or more criteria relating to the distribution of the product includes a mode of transportation, a type of packaging and a cost of the distribution option.

10. The method of claim 1, wherein providing the set of distribution options includes identifying at least one of the distribution options as a green distribution option based on the one or more criteria.

11. The method of claim 1, wherein obtained data relating to the distribution of the product includes at least one of: material(s) used for packaging the product, mode of transportation available to ship the product, distance between the supplier and the customer, and amount of carbon emission associated with each mode of transportation.

12. A computer implemented method for analyzing distribution options, comprising:
obtaining data relating to a current mode of distributing a product to a customer from at least one supplier and data relating to one or more alternative options of distributing the product;
configuring one or more criteria relating to the distribution of the product, wherein at least one criteria relates to sustainability of distributing the product;
weighting the criteria;
performing green distribution analysis, by the computer, on the current mode of distributing the product and on the one or more alternative options of distributing the product based on the weighted criteria using the obtained data; and
providing, by the computer, a comparison of the current mode of distributing the product and the one or more alternative options of distributing the product based on the results of the green distribution analysis.

13. The method of claim 12, wherein providing of the comparison includes providing one or more of the alternative options that, based on the results of the green distribution analysis, can improve the sustainability of distributing the product.

14. The method of claim 12, wherein the weighting of the one or more criteria is performed based on at least one of customer characteristics, industry standards, certification standards, government policies, regulation requirements, transportation options, fuel prices, and supplier characteristics.

15. The method of claim 12, wherein the weighting of the one or more criteria can be changed based on changing political situation, customer characteristic or supplier characteristics.

16. The method of claim 12, further comprising selecting one of the alternative options of distributing the product if it is determined that at least one of the alternative options is more sustainable than the current mode of distributing the product.

17. The method of claim 12, wherein the current mode of distributing the product and the alternative options of distributing the product are ranked based on the sustainability of distributing the product with each option.

18. The method of claim 12, wherein performing the green distribution analysis includes calculating a cost associated with the current mode of distributing the product and the one or more alternative options of distributing the product.

19. A non-transitory computer readable medium comprising a set of stored instructions that, when executed by a processing device, cause the processing device to:
obtain data relating to the distribution of the product to a customer from at least one supplier;
configure one or more criteria relating to the distribution of the product, wherein at least one criteria relates to sustainability of the distribution of the product;
weight the criteria;
perform green distribution analysis on the distribution options of the product based on the weighted criteria using the obtained data; and
provide a set of distribution options based on the green distribution analysis.

20. A computer system for analyzing the sustainability of distributing a product comprising:
a data storage device storing data relating to the distribution of the product to a customer from at least one supplier;
a processor in communication with the data storage device, the processor being configured to:
configuring one or more criteria relating to the distribution of the product, wherein at least one criteria relates to sustainability of the distribution of the product;
weighting the criteria;
performing green distribution analysis, by the computer, on the distribution options of the product based on the weighted criteria using the data stored in the data storage device; and
providing a set of distribution options based on the green distribution analysis.
